(19) United States
(12) Patent Application Publication
(10) Pub. No.: US 2011/0160520 A1
(43) Pub. Date: Jun. 30, 2011

(54) WARMING THERAPY DEVICE INCLUDING PUMP ASSEMBLY WITH INTEGRATED HEATING ELEMENT

(75) Inventors: Andrei Khodak, Hatfield, PA (US); Peter D. Sabota, Warminster, PA (US)

(73) Assignee: DRAEGER MEDICAL SYSTEMS, INC., Telford, PA (US)

(21) Appl. No.: 13/062,417

(22) PCT Filed: Sep. 25, 2009
(86) PCT No.: PCT/US09/58317

§ 371 Date: Mar. 4, 2011

Related U.S. Application Data
(60) Provisional application No. 61/112,383, filed on Nov. 7, 2008.

(51) Int. Cl. A61G 11/00

(52) U.S. Cl. 600/22

(57) ABSTRACT

An apparatus and method for performing warming therapy is described. In one exemplary embodiment, the apparatus includes a patient support assembly and a pump assembly coupled to the patient support assembly, for providing heated air to a patient. The pump assembly may include one or more heating elements coupled to the sidewalk thereof for providing heating of air flowing through the pump assembly.

### CROSS REFERENCE TO RELATED APPLICATIONS

This application claims priority to U.S. Provisional Application Ser. No. 61/112,383, filed Nov. 7, 2008, the entire contents of which is hereby incorporated by reference, as if fully set forth herein.

### FIELD OF THE INVENTION

This present invention relates generally to a method and apparatus for performing warming therapy on medical patients. More particularly, the present invention relates to a method and apparatus for providing heating to a medical patient utilizing a pump assembly with heating members integrated into the walls of the assembly.

### BACKGROUND OF THE INVENTION

Warming therapy devices are known to provide heated air to an environment surrounding a medical patient (e.g., infant) to promote growth and development. Incubators are a type of warming therapy device that utilize a hood to enclose a patient, and thereby isolate him or her from the outside environment. In many incubators, the various parameters of the microenvironment within which the patient is disposed (i.e., the area inside the hood of the incubator) are controlled using sensors and other devices. For example, heat within the microenvironment is often provided and controlled using standard air pumps (e.g., fans) and convective heaters. In such a scenario, the convective heater generates heat which is carried to the patient by microenvironment air, which is put in motion by the air pump. In many cases, the convective heaters are disposed separately from the air pumps (and in some cases a discrete distance away from the air pumps), which results in hydraulic losses in the air circulation system. For example, convective heaters in warming therapy devices are often equipped with ribs and/or other members which intensify heat exchange between the heater and the microenvironment air, and such members can cause hydraulic losses, which impact the efficiency of the air circulation system.

For example, U.S. Pat. No. 4,846,783, the disclosure of which is hereby incorporated by reference in this application, as if fully set forth herein, shows a conventional warming therapy device (i.e., incubator) including a fan 2 and heater 4 for supplying heated air to an infant patient disposed on a cot 9 overlying a resting surface 7. The fan 2 blows air past the heater 4, where it is heated and provided to an air outlet 21, and subsequently to the infant patient. The air outlet 21 includes a plurality of guide ribs 24 for guiding the air flow upward through an intermediate space 30, and into the incubator interior 6.

U.S. Pat. No. 5,935,055, the disclosure of which is hereby incorporated by reference in this application, as if fully set forth herein, shows another conventional warming therapy device including a lying surface 1 for a patient, and a housing 8 (i.e., hood) for surrounding the patient. Also included are a fan 4 and electric drive motor 5 for rotating the fan. A circular air heater 6 surrounds the fan 4 and operates to heat the air inside the housing 8. In particular, heated air is blown by the fan 4 to first and second nozzles 11 (as shown by the directional arrows in FIG. 2), where it is transmitted into the upper part of the housing 8 through parallel slots 7 which run along the two long sides of the housing. Exhaust slots 9 are provided along the two short sides of the housing 8 for collecting the air transmitted to the upper portion of the housing, and for returning such air to the area around the fan 4.

However, the air heating and circulation systems associated with conventional warming therapy devices (such as the ones discussed above) often have reduced hydrodynamic efficiency, due to the separation between the respective fans and the heater exchange intensification members (such as ribs). Such conventional systems are also often large in size, due to the separation of the fans and heaters, and also due to ancillary portions of the system (e.g., air guide ribs, heat transfer ribs). Conventional systems including such ancillary portions are also often difficult to clean, due to the location and configuration of such ancillary portions. For example, the air guide ribs discussed above with regard to U.S. Pat. No. 4,846,783 are integrated into the base of the warming therapy device, and thus difficult to access and clean using standardized methods. Because one of the objectives of a warming therapy device is to create a sterile and hygienically sound environment for the patient, an air heating and circulation system, which may be easily disassembled and cleaned is highly desirable. Finally, the air heating and circulation systems associated with conventional warming therapy devices often include electrical connections to the heater, which are exposed in some manner to the oxygen present within the device. Accordingly, any broken connection or wire could potentially cause a fire in an oxygen-rich environment such as inside the warming therapy device.

Accordingly, there is presently a need for a warming therapy device that includes an air heating and circulation system which is small in size, which may be easily disassembled and cleaned, and which is not subject to substantial fire risks, but which also maintains a high hydrodynamic efficiency.

### SUMMARY OF THE INVENTION

An exemplary embodiment of the present invention comprises an apparatus including a patient support assembly and a pump assembly coupled to the patient support assembly, wherein the pump assembly includes a volute housing with first and second portions, and a heating element coupled to the first portion of the volute housing.

An exemplary embodiment of the present invention also comprises an apparatus including a patient support assembly, a mattress tray assembly coupled to the patient support assembly, and a pump assembly coupled to the mattress tray assembly, wherein the pump assembly includes a volute housing with first and second portions, and a heating element coupled to the first portion of the volute housing.

An exemplary embodiment of the present invention also comprises a method of providing warming therapy to a patient, the method including the steps of providing a mattress tray assembly for supporting a patient, providing a pump assembly in proximity to the mattress tray assembly, the pump assembly including a volute housing with first and second portions, and a heating element coupled to the first portion of the volute housing, and activating the pump assembly to force air through the pump assembly, said air being heated by the pump assembly and being output to the area surrounding the mattress tray assembly for warming the patient.

### BRIEF DESCRIPTION OF THE DRAWINGS

FIG. 1 is perspective view of a warming therapy device according to a first exemplary embodiment of the present invention.

FIG. 2 is an overhead perspective view of the warming therapy device of FIG. 1.

FIG. 3 is top partial cross-section view of a pump assembly according to a first exemplary embodiment of the present invention.

FIG. 4 is top partial cross-section view of a pump assembly according to a second exemplary embodiment of the present invention.

FIG. 5 is a top plan view of the pump assembly shown in FIG. 4, without the thermal insulation layer and with the heating element extending the length of the volute.

FIG. 6 is a perspective view of the pump assembly shown in FIG. 4, without the thermal insulation layer and with the heating element extending the length of the volute.

FIG. 7 is an exploded perspective view of a mattress tray assembly according to an exemplary embodiment of the present invention.

FIG. 8 is a side cross-section view of the mattress tray assembly shown in FIG. 7, with an infant patient disposed therein.

### DETAILED DESCRIPTION

The present invention relates to a warming therapy device (e.g., incubator, warmer, etc.) including a pump assembly with an integrated heating element. In particular, the warming therapy device includes a pump assembly with a volute for circulating and distributing air which includes heated sidewalls.

Conventional warming therapy devices use standard air pumps and separate convective heaters. In many cases, the convective heaters are disposed separately from the air pump (and in some cases a discrete distance away from the air pump). Such separation, coupled with the introduction of heat transfer intensification members (e.g., ribs coupled to the heaters), can lead to a loss in hydrodynamic efficiency of the overall heating system. The present invention allows efficient convective heating of air without a corresponding reduction in the hydrodynamic efficiency of the air circulation system. Another advantage of the present invention is reduction in size. Particularly, by combining the air pump and the heater into a single assembly, space inside the warming therapy device is conserved, and thus the overall size of the warming therapy device structure may be decreased. Yet another advantage is the ease of cleaning the pump assembly as compared to conventional pump and heater assemblies. In particular, standard heaters normally use a plurality of ribs to intensify heat transfer from the heater to the surrounding air. These ribs can make heaters difficult to clean, due to their size and placement. The present invention allows heat transfer intensification by positioning the heater in the volute of the air pump (where air velocity is high), so that the walls of the volute are flat, and do not include any ribs or other heat transfer intensification members, making them easier to clean. Yet another advantage of the present invention is a separation of the heated fluid or gas (in the volute) and the electrical connection to the heater (which may be disposed outside the volute). This is an important safety feature when, for example, the gas traveling in the volute is oxygen rich air.

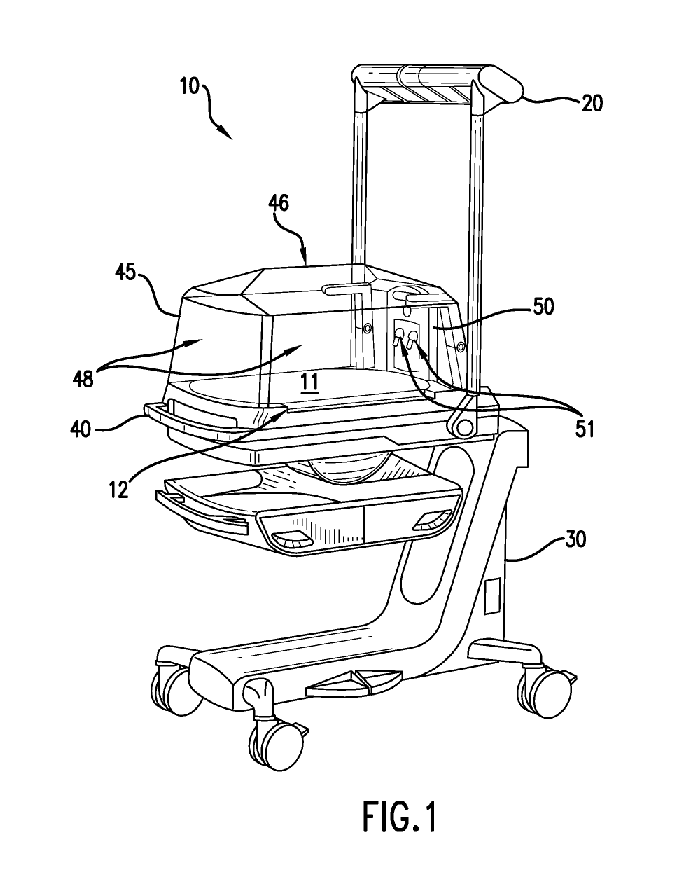

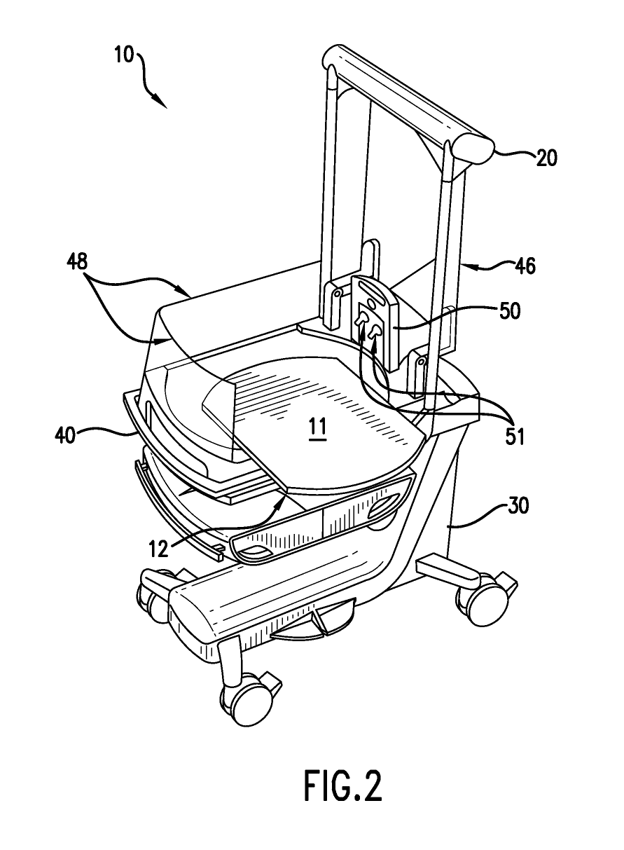

FIGS. 1 and 2 show a warming therapy device 10 according to a first exemplary embodiment of the present invention. The warming therapy device 10 includes a radiant heater head 20, and a patient support assembly 30 including a mattress tray assembly 40. The mattress tray assembly 40 may include a hood 45 which has a top portion 46 which pivots about one or more axes 47. The hood 45 may also include one or more sidewalls 48 which may be slideable, removable, pivotable or rotatable. The mattress tray assembly 40 also preferably includes a mattress tray 42, with a mattress 41 disposed therein. The warming therapy device 10 may optionally include a backplane 50, to which ventilation hoses and other devices may be coupled through, for example, interconnection nozzles 51.

FIG. 2 shows the top portion 46 of the hood 45 rotated up so that it is approximately ninety degrees (90°) with respect to the mattress tray 42. In the exemplary embodiment shown in FIG. 2, the sidewalls 48 of the hood 45 are capable of sliding vertically within a portion of the mattress tray assembly 40, so that they may become disposed, partially or completely, below the plane of the mattress tray 42.

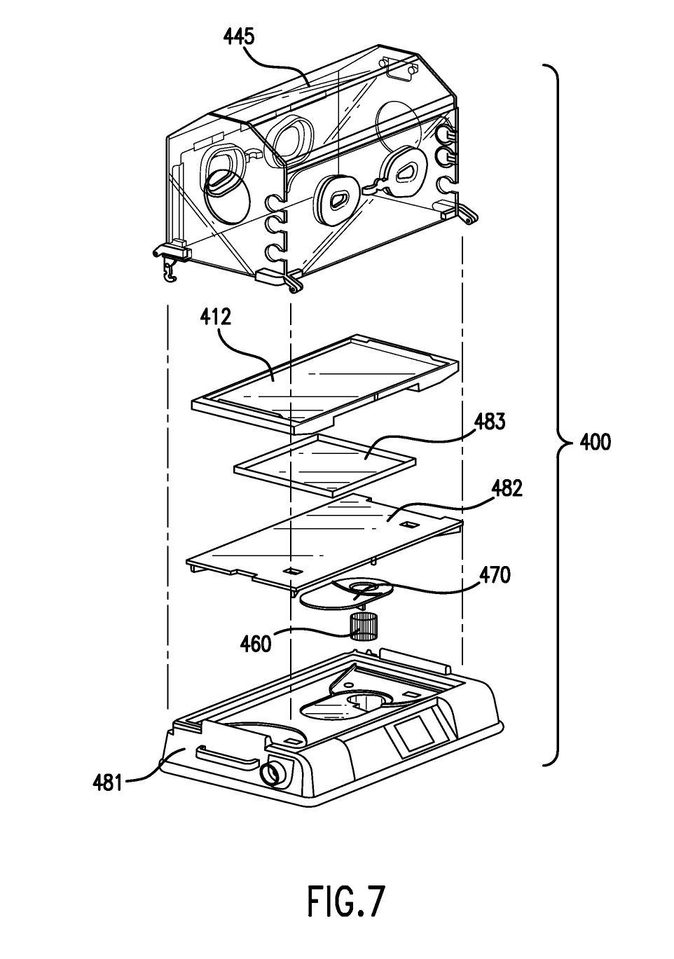

Referring again to FIGS. 1 and 2, either of the patient support assembly 30, or the mattress tray assembly 40 of the warming therapy device 10, may include a pump assembly 200, 300 (as described below) for circulating heated air to a patient disposed on the mattress 41. For example, the pump assembly may be disposed within the mattress tray assembly 40, as a position directly underneath the mattress tray 42. FIG. 7, discussed below, shows an exemplary embodiment of how either of the pump assemblies 200, 300 may be integrated with a warming therapy device.

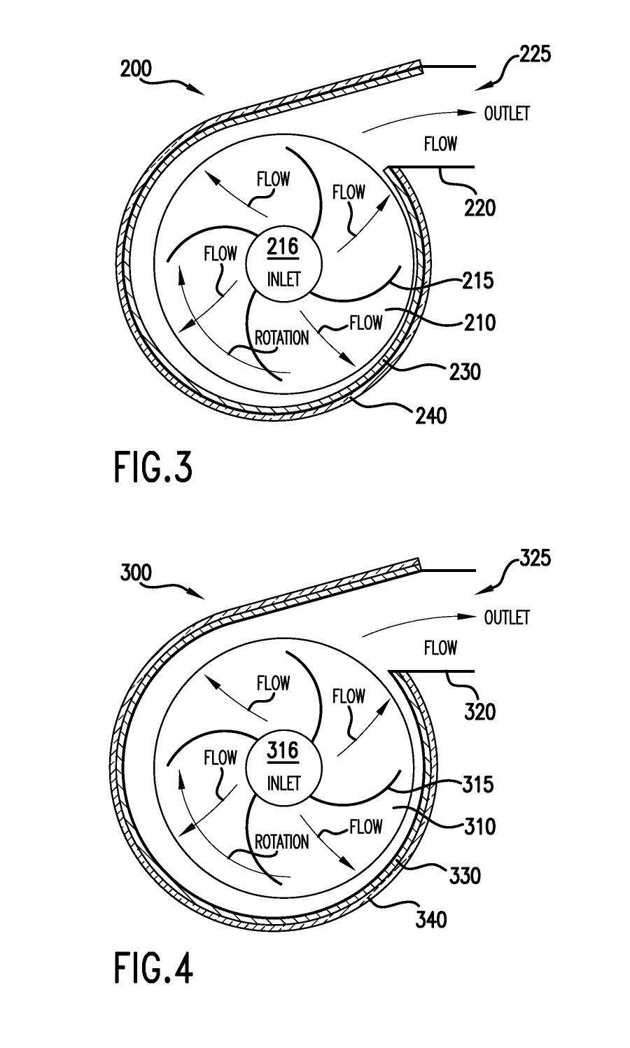

FIG. 3 shows a pump assembly 200 according to a first exemplary embodiment of the present invention. The pump assembly 200 includes a rotor 210 (e.g., fan and motor), a volute housing 220, a heating element 230, and a thermal insulation layer 240. The rotor 210 may include one or more blades 215 for circulating gas (e.g., air, oxygen, etc.) or liquid through the pump assembly 200. The rotor 210 also includes an inlet or intake 216 passage disposed at the center of the blades 215. The volute housing 220 includes an outlet passage 225, where air circulated within the rotor 210 leaves the volute housing.

The rotor 210 rotates within the volute housing 220, and pumping action is achieved by rotation of the blades 215 within the gas or liquid-filled area. The rotor 210 may rotate clockwise (as shown in FIG. 3), or counterclockwise. In either rotating direction, gas or liquid enters through the inlet passage 216, and is pushed towards the outer edges of the rotor 210, as shown by the smaller “FLOW” lines in FIG. 3. The gas or liquid continues to flow out through the outlet passage 225, as shown by the larger “FLOW” line in FIG. 3. As an alternative to the rotor 210 shown in FIG. 3, other mechanisms may be used to impose rotation on the gas or liquid, such as a “Tesla” pump, which can circulate gas and/or liquid through viscous friction. The gas or liquid is circulated within the rotor and moved towards the outlet passage 225 of the volute housing 220. Gas or liquid, which enters the pump assembly 200 through the intake 216, obtains a dynamic pressure as it is rotated within the rotor 210. This dynamic pressure is converted into static pressure at the outlet passage 225.

FIG. 4 shows a pump assembly 300 according to a second exemplary embodiment of the present invention. The pump assembly 300 is similar in many respects to the pump assembly 200 described above, and like reference numerals denote like elements. One difference between the pump assembly 300 and the pump assembly 200 is the placement of the heating element and thermal insulation layers. Particularly, the heating element and thermal insulation layer are both disposed on an outer side of a wall of the volute housing. The pump assembly 300 includes a rotor 310 (e.g., fan and motor), a volute housing 320, a heating element 330, and a thermal insulation layer 340. The rotor 310 may include one or more blades 315 for circulating gas (e.g., air, oxygen, etc.) or liquid through the pump assembly 300. The rotor 310 also includes an inlet or intake passage 316 disposed at the center of the blades 315. The volute housing 320 includes an outlet passage 325, where gas or liquid circulated within the rotor 310 leaves the volute housing. As with the pump assembly 200, the rotor 310 rotates within the volute housing 320, and pumping action is achieved by rotation of the blades 315 within the gas or liquid-filled area.

As noted above, the heating elements 230, 330 may be coupled to the wall of the respective volute housings 220, 320 on the inside, as shown in FIG. 3, or on the outside, as shown in FIG. 4. Alternatively, the heating elements 230, 330 may be coupled to the inside wall of the respective volute housings 220, 330 using over-molding or other equivalent technologies. The heating elements 230, 330 may comprise electrical heating elements, such as flexible flat heating elements which can be coupled to the walls of the respective volute housings 220, 320 through adhesive, glue, or other equivalent attachment means. Alternatively, the heating elements 230, 330 may comprise electrical or non-electrical heating elements, such as a Peltier thermoelectric element, resistive heating elements mounted into the volute wall, or any other surface which provides heating, which can be shaped in the form of the walls of the respective volute housings 220, 320.

In operation, the heating elements 230, 330 may heat the rotors 210, 310 and blades 215, 315 through thermal radiation, in which case the gas or liquid within the respective assembly is further heated by the rotors. The gas or liquid within the pump assemblies 200, 300 should be substantially transparent to thermal radiation for efficient heating of the rotors 210, 310, but such is not a requirement of the present invention. For example, air has a high transparency to thermal radiation, and therefore will provide a good medium for operation of the pump assemblies 200, 300. Alternatively, gases and liquids with lower infrared transparency such as water or water vapor will be heated directly by thermal radiation from the volute wall heaters.

As noted above, the thermal insulation layers 240, 340 may be coupled to the outside wall of the respective volute housings 220, 320, as shown in FIG. 3, or to an outer surface of the heating element 330, as shown in FIG. 4. In either embodiment, the thermal insulation layers 230, 330 substantially prevent excessive heat loss from the pump assemblies 200, 300.

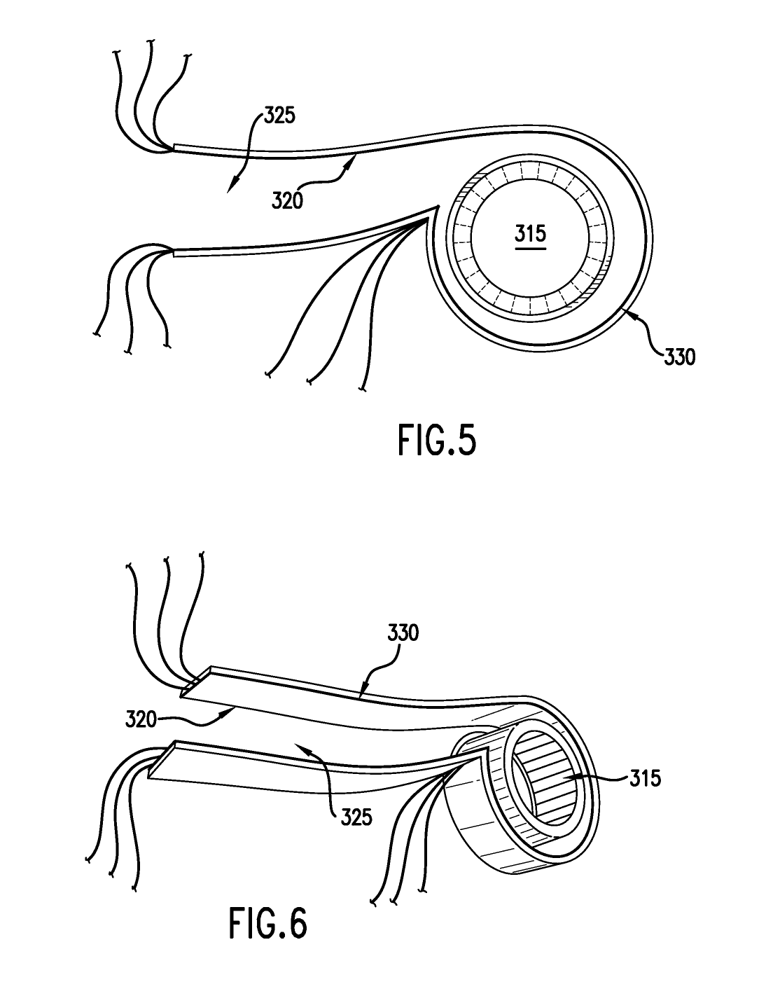

Although FIGS. 3 and 4 show the heating elements 230, 330 and the thermal insulation layers 240, 340 terminating near the respective outlet passages 225, 325 of the volute housings 220, 320, those of ordinary skill in the art will realize that the heating elements 230, 330 and/or the thermal insulation layers 240, 340 may continue on, depending on the length of the outlet passages 225, 325, and the amount of heating required. For example, FIGS. 5 and 6 show an exemplary pump assembly, which is similar to the pump assembly 300 shown in FIG. 4, where the heating element 330 is disposed on an outer wall of the volute housing 320. The pump assembly shown in FIGS. 5 and 6 includes a volute housing 320 with an extended outlet passage 325, where the heating element 330 extends the entire length of the volute housing.

FIG. 7 shows an exploded perspective view of a mattress tray assembly 400 according to an exemplary embodiment of the present invention, which includes at least one of the above-described pump assemblies 200, 300 disposed within a support base 481. The mattress tray assembly 400 is similar to the mattress tray assembly 40 shown in FIGS. 1 and 2, and like reference numerals denote like elements.

The mattress tray assembly 400 may include a hood 445 for creating an incubation chamber, and may also include a mattress tray 412 for receiving a mattress (not shown). The support base 481 may include one or more rotors 460, which form part of the above-described pump assemblies 200, 300. The rotors 460 may be inserted within the support base 481 as shown, and sealed by a rotor cover 470. The support base 481 may also include a cover 482, and a weight scale 483 disposed beneath the mattress tray 412. Although the exemplary embodiment shown in FIG. 7 includes only one rotor 460 (and correspondingly one pump assembly and/or volute housing), those of ordinary skill in the art will understand that two or more rotors 460 may be disposed within the support base 481, each corresponding to a respective pump assembly or volute housing. As will be further understood by those of ordinary skill in the art, when utilizing multiple rotors 460, the volute housings (e.g., 220, 320) of the pump assemblies (e.g., 200, 300) may be formed as separate units, or as a unitary member. The use of a pump assembly with two or more volutes, or the use of two or more pump assemblies, provides the benefits of efficiency and scalability. In particular, if only a small amount of heating is required, only one of the rotors 460 need be activated, which may in turn circulate heated air in only one of the pump assemblies and/or volute housings, thus conserving energy. Alternatively, if a large amount of heating is required, one or more of the additional rotors 460 may be activated, which in turn circulates heated air in the additional pump assemblies and/or volute housings, decreasing the overall time required to heat the associated warming therapy device, and thus conserving energy.

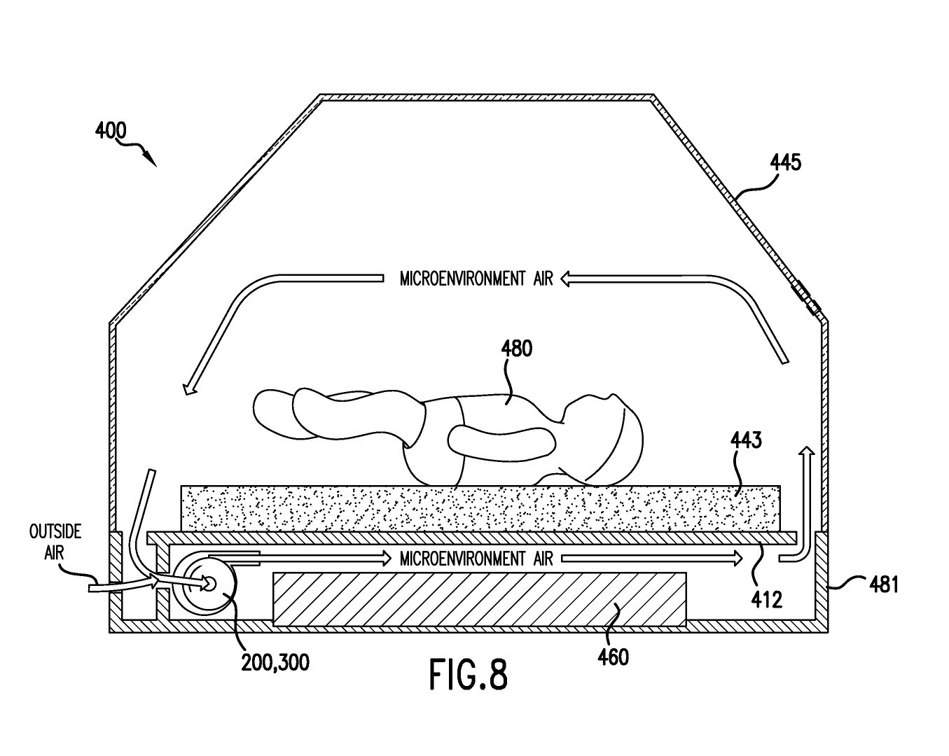

FIG. 8 is a side cross-section view of the mattress tray assembly 400, showing the placement of the pump assembly (e.g., pump assembly 200 or 300), and an infant patient 480 disposed thereon. As shown, either pump assembly 200, 300 may be disposed within the mattress tray assembly 400 at a position underneath the mattress tray 412, and the infant patient 480. FIG. 8 also shows a mattress 443 disposed on the mattress tray 412, on which is disposed the infant patient 480. FIG. 8 also shows an optional convective heater 460 which may be disposed within the mattress tray assembly 400, and used for additional heating, if necessary. As shown, air is drawn in from outside the mattress tray assembly 400 by the pump assembly, and then circulated to the microenvironment surrounding the infant patient 480. Due partially to the configuration of the hood 445, the heated air passes over the body of the infant patient 480, and back into the pump assembly. This process creates a heated microenvironment of the desired temperature for the infant patient 480.

As will be noted by those of ordinary skill in the art, the pump assemblies 200, 300 according to first and second exemplary embodiments may be integrated into a warming therapy device such as the device 10 shown in FIG. 1. For example, the pump assemblies 200, 300 may be formed inside the patient support assembly 30 at a position underneath the mattress tray 42.

Further, although the pump assemblies 200, 300 according to the first and second exemplary embodiments are shown and described above with reference to an associated warming therapy device 10 of a specific configuration, those of ordinary skill in the art will realize that the pump assemblies 200, 300 may be integrated into any suitable incubator, warmer, medical treatment device or other equivalent apparatus. Those of ordinary skill in the art will also realize that the pump assemblies 200, 300 may be used in other medical or non-medical applications, where efficient convective heating is required without significant losses in hydraulic efficiency. Further, although the pump assemblies 200, 300 are described above with reference to air or oxygen comprising the circulated gas or liquid, those of ordinary skill in the art will realize that the any liquid or gas may be heated and circulated using the pump assemblies 200, 300 according to the present invention.

Although exemplary embodiments of the present invention has been described above for use in procedures involving infant patients, those of ordinary skill in the art will realize that the warming therapy device 10, and pump assemblies 200, 300, according to the exemplary embodiments of the present invention, may be used for other types of operations and procedures, including for children and adults without departing from the scope of the present invention.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus comprising:
a patient support assembly; and,
a pump assembly coupled to the patient support assembly, wherein the pump assembly includes a volute housing with first and second portions, and a heating element coupled to the first portion of the volute housing.

2. The apparatus of claim 1, wherein the pump assembly further comprises a rotor disposed within the first portion of the volute housing.

3. The apparatus of claim 2, wherein the pump assembly further comprises an inlet passage.

4. The apparatus of claim 3, wherein the inlet passage is disposed substantially centrally within the rotor.

5. The apparatus of claim 1, wherein the pump assembly further comprises a thermal insulating layer coupled to the first portion of the volute housing.

6. The apparatus of claim 2, wherein the rotor includes a plurality of blades.

7. The apparatus of claim 1, wherein the pump assembly further comprises an outlet passage.

8. The apparatus of claim 1, wherein the heating element is coupled to an inner wall of the first portion of the volute housing.

9. The apparatus of claim 1, wherein the heating element is coupled to an outer wall of the first portion of the volute housing.

10. The apparatus of claim 8, wherein the pump assembly further comprises a thermal insulating layer coupled to an outer wall of the first portion of the volute housing.

11. The apparatus of claim 9, wherein the pump assembly further comprises a thermal insulating layer coupled to an outer wall of the heating element.

12. The apparatus of claim 1, wherein the first portion of the volute housing is substantially circular.

13. The apparatus of claim 12, wherein the heating element is coupled to the second portion of the volute housing, the second portion of the volute housing being substantially linear.

14. An apparatus comprising:
a patient support assembly;
a mattress tray assembly coupled to the patient support assembly; and,
a pump assembly coupled to the mattress tray assembly, wherein the pump assembly includes a volute housing with first and second portions, and a heating element coupled to the first portion of the volute housing.

15. The apparatus of claim 14, wherein the mattress tray assembly further comprises:
a mattress tray for receiving a mattress; and
a hood for covering a portion of the mattress tray.

16. The apparatus of claim 14, wherein the mattress tray assembly further comprises:
a support base; and
a cover, wherein the pump assembly is disposed within the support base and covered on a first side by the cover.

17. The apparatus of claim 14, wherein the mattress assembly further comprises a convective heater disposed adjacent the pump assembly.

18. The apparatus of claim 14, wherein the heating element is coupled to an inner wall of the first portion of the volute housing.

19. The apparatus of claim 14, wherein the heating element is coupled to an outer wall of the first portion of the volute housing.

20. A method of providing warming therapy to a patient, the method comprising:
providing a mattress tray assembly for supporting a patient;
providing a pump assembly in proximity to the mattress tray assembly, the pump assembly including a volute housing with first and second portions, and a heating element coupled to the first portion of the volute housing; and
activating the pump assembly to force air through the pump assembly, said air being heated by the pump assembly and being output to the area surrounding the mattress tray assembly for warming the patient.

21. The method of claim 20, wherein the heating element is coupled to an inner wall of the first portion of the volute housing.

22. The method of claim 20, wherein the heating element is coupled to an outer wall of the first portion of the volute housing.
